(19) United States
(12) Patent Application Publication
(10) Pub. No.: US 2024/0220887 A1
(43) Pub. Date: Jul. 4, 2024

(54) SYSTEM AND METHOD FOR DETERMINING RANGE OF ESTIMATES USING MACHINE LEARNING

(71) Applicant: Copperleaf Technologies Inc., Vancouver (CA)

(72) Inventors: Jean-François LALIBERTÉ, Vancouver (CA); Danilo PRATES DE OLIVEIRA, Vancouver (CA); Alejandro ERICKSON, Burnaby (CA); Alvin NURSALIM, Burnaby (CA)

(21) Appl. No.: 18/090,341

(22) Filed: Dec. 28, 2022

(51) Int. Cl. G06Q 10/0631; G06Q 10/0637

(52) U.S. Cl. CPC G06Q 10/06312; G06Q 10/06375

(57) ABSTRACT

A method, apparatus and system for determining project attribute range values for at least one project attribute, such as a project cost and/or a project schedule, of at least one new project include receiving historical data related to at least one previous performance of a same or similar project as the at least one new project, the historical data including historical project attribute values of the at least one project attribute, generating multiple respective machine learning models using different sets of training data determined from the received historical data, each of the different sets of the training data being used to train a respective one of the machine learning models, and determining a range of values for the at least one project attribute of the at least one new project by applying the multiple respective machine learning models to the at least one project attribute of the new project.

### FIELD

The present disclosure relates, generally, to estimation of project attributes and more particularly, to methods, apparatuses and systems which predict a range of estimates of project attributes, such as project cost and scheduling, using machine learning techniques.

### BACKGROUND

Asset-intensive industries, such as electrical utilities, rail networks, and water distribution companies, may experience challenges around estimating the costs of undertaking various projects. For example, some organizations, e.g., a power company, can have in excess of thirty thousand assets (e.g., circuits, relays, transformers, etc.) on a plurality of circuits of an electrical transmission network that need to be maintained and sometimes repaired, upgraded, replaced, or refurbished. In current day, project owners use domain knowledge and/or a predictive model with parametric or quantile prediction intervals to estimate project costs and variances. Such methods are often inflexible and limited to the ability of individuals or the predictive model applied to model the data distribution of completed projects in the past. What is needed is a method, apparatus and system that enable project owners to predict a range of estimates for data-driven project attributes according to relative prediction intervals without the need to select a single predictive model that can produce parametric or quantile prediction intervals.

### SUMMARY

The present disclosure relates, generally, to methods, apparatuses and systems for predicting a range of estimates for project attributes, and more particularly, to methods, apparatuses and systems for predicting at least one of a cost-range estimate or a schedule-range estimate for project attributes of at least one new project in some embodiments, in the form of prediction intervals, using determined, respective machine learning models.

In some embodiments, a method for determining project attribute range values for at least one project attribute, such as a project cost and/or a project schedule, of at least one new project includes receiving historical data related to at least one previous performance of a same or similar project as the at least one new project, the historical data including historical project attribute values of the at least one project attribute, generating multiple respective machine learning models using different sets of training data determined from the received historical data, each of the different sets of the training data being used to train a respective one of the machine learning models, and determining a range of values for the at least one project attribute of the at least one new project by applying the multiple respective machine learning models to the at least one project attribute of the new project.

In some embodiments, the method can further include determining the different sets of training data from the received historical data by repeatedly applying a sampling technique to the historical data.

In some embodiments, the method can further include applying testing data to the generated multiple machine learning models to determine a validity of the multiple machine learning models, wherein only ones of the multiple machine learning models determined to be valid are applied to the at least one project attribute of the new project to determine a range of values for the at least one project attribute of the at least one new project.

In some embodiments, the method can further include determining a prediction interval and determining the range of values for the at least one project attribute of the at least one new project in accordance with the determined prediction interval.

In some embodiments, an allocation of resources for the at least one project is based on the range of values determined for the at least one project attribute of the at least one new project.

In some embodiments, a computer implemented method for training multiple respective machine learning models for determining a range of values for at least one project attribute of at least one new project includes receiving historical data related to at least one previous performance of a same or similar project as the at least one new project, the historical data including project attribute values of the at least one project attribute, applying a sampling technique to the historical data to generate a first subset of data including historical project attribute values, creating a first training set comprising the generated first subset of data, training a first machine learning model in a first stage using the first training set, applying the sampling technique to the historical data to generate a different, second subset of data including at least some different historical project attribute values as in the first training set, creating a second training set comprising the generated different, second subset of data, and training a second machine learning model in a second stage using the second training set.

In some embodiments, the method can further include applying the sampling technique to the historical data to generate at least a third, different subset of data including at least some different historical project attribute values as in the first training set and the second training set, creating at least a third training set comprising the generated different, at least the third subset of data, and training at least a third machine learning model in at least a third stage using the at least the third training set.

In some embodiments, the method can further include applying the trained, multiple machine learning models to the at least one project attribute of the new project to determine a range of values for the at least one project attribute of the at least one new project.

In some embodiments, a non-transitory machine readable medium includes, stored thereon, at least one program, the at least one program including instructions which, when executed by a processor, cause the processor to perform a method in a processor-based system for determining project attribute range values for at least one project attribute of at least one new project, including receiving historical data related to at least one previous performance of a same or similar project as the at least one new project, the historical data including project attribute values of the at least one project attribute, generating multiple respective machine learning models using different sets of training data determined from the received historical data, each of the different sets of the training data being used to train a respective one of the machine learning models, and determining a range of values for the at least one project attribute of the at least one new project by applying the multiple respective machine learning models to the at least one project attribute of the new project.

In some embodiments, the method can further include determining the different sets of training data from the received historical data by repeatedly applying a sampling technique to the historical data.

In some embodiments, the method can further include applying testing data to the generated multiple machine learning models to determine a validity of the multiple machine learning models, wherein only ones of the multiple machine learning models determined to be valid are applied to the at least one project attribute of the new project to determine a range of values for the at least one project attribute of the at least one new project.

In some embodiments, the method can further include determining a prediction interval and determining the range of values for the at least one project attribute of the at least one new project in accordance with the determined prediction interval.

In some embodiments, a system for determining project attribute range values for at least one project attribute of at least one new project includes at least one data source and a computing device including a processor and a memory having stored therein at least one program, the at least one program including instructions which, when executed by the processor, cause the computing device to perform a method including receiving historical data related to at least one previous performance of a same or similar project as the at least one new project, the historical data including project attribute values of the at least one project attribute, generating multiple respective machine learning models using different sets of training data determined from the received historical data, each of the different sets of the training data being used to train a respective one of the machine learning models, and determining a range of values for the at least one project attribute of the at least one new project by applying the multiple respective machine learning models to the at least one project attribute of the new project.

In some embodiments, the method further includes determining the different sets of training data from the received historical data by repeatedly applying a sampling technique to the historical data.

In some embodiments, the method further includes applying testing data to the generated multiple machine learning models to determine a validity of the multiple machine learning models, wherein only ones of the multiple machine learning models determined to be valid are applied to the at least one project attribute of the new project to determine a range of values for the at least one project attribute of the at least one new project.

In some embodiments, the training data includes data of the historical data not used for training the multiple machine learning models, and wherein the historical data is separated into at multiple training datasets and at least one testing dataset using random stratification and grouping of records which preserves an original shape of the historical data and preserves main characteristics of the historical data.

In some embodiments, the method further includes determining a prediction interval and determining the range of values for the at least one project attribute of the at least one new project in accordance with the determined prediction interval.

Other and further embodiments of the present disclosure are described below.

### BRIEF DESCRIPTION OF THE DRAWINGS

Embodiments of the present disclosure, briefly summarized above and discussed in greater detail below, can be understood by reference to the illustrative embodiments of the disclosure depicted in the appended drawings. However, the appended drawings illustrate only typical embodiments of the disclosure and are therefore not to be considered limiting of scope, for the disclosure may admit to other equally effective embodiments.

FIG. 1 depicts a high-level block diagram of a project attribute estimation (PAE) system embodied in a computing device in accordance with an embodiment of the present principles.

FIG. 2 depicts a graphical representation of the functionality of a PAE system, such as the PAE system of FIG. 1, in accordance with an embodiment of the present principles.

FIG. 3 depicts a graphical representation of a more detailed description of the functionality of a Machine Learning Aggregator module including an Automated Machine Learning Tool of the present principles, in accordance with an embodiment of the present principles.

FIG. 4 depicts a flow diagram of a method for generating/training multiple respective machine learning models using different sets of training data, in accordance with an embodiment of the present principles.

FIG. 5 depicts a graphical representation of a functionality of the Project Attribute Estimator of FIG. 2 in accordance with an embodiment of the present principles.

FIG. 6 depicts a flow diagram of a method for project attribute range values for at least one project attribute of at least one new project, in accordance with an embodiment of the present principles.

FIG. 7 depicts a high-level block diagram of a network in which embodiments of a PAE system in accordance with the present principles can be applied.

To facilitate understanding, identical reference numerals have been used, where possible, to designate identical elements that are common to the figures. The figures are not drawn to scale and may be simplified for clarity. Elements and features of one embodiment may be beneficially incorporated in other embodiments without further recitation.

### DETAILED DESCRIPTION

The following detailed description describes techniques (e.g., methods, apparatuses, and systems) for providing a range of estimates of project attributes, such as cost and scheduling attributes, using machine learning techniques. In some embodiments, the described techniques of the present principles can integrate with an Asset Planning and Management (APM) software program/system, such as the APM described in commonly owned patent application Ser. No. 17/849,021, filed Jun. 24, 2022 and entitled “METHODS AND APPARATUS FOR CREATING ASSET RELIABILITY MODELS”, which is herein incorporated by reference in its entirety. That is, in some embodiments of the present principles, project attribute (e.g., cost and schedule) range estimates determined by a Project Attribute Estimator (PAE) system of the present principles can be communicated to an Asset Planning and Management (APM) system, which can adjust a shared budget (e.g., financial budget, scheduling budget, labor budget, etc.) based on the predicted project attribute range estimates. Resulting budget adjustments can then be used as inputs to a PAE system of the present principles to close a loop (described in greater detail below). Alternatively or in addition, in some embodiments of the present principles, the project attribute range estimates determined by a PAE system of the present principles can be stored as, for example, historical data, and can be used by a same or different PAE system of the present principles in determining subsequent project attribute range estimates.

While the concepts of the present principles are susceptible to various modifications and alternative forms, specific embodiments thereof are shown by way of example in the drawings and are described in detail below. It should be understood that there is no intent to limit the concepts of the present principles to the particular forms disclosed. On the contrary, the intent is to cover all modifications, equivalents, and alternatives consistent with the present principles and the appended claims. For example, although embodiments of the present principles are described with reference to determining cost estimates and scheduling estimates for projects, embodiments of the present principles can be implemented to determine estimates of other project attributes.

In some embodiments, a Project Attribute Estimator (PAE) system of the present principles predicts a range of a project's cost and/or schedule with prediction intervals by analyzing historical records of project costs and schedules and applying techniques in machine learning and statistics. In some embodiments, outputs in the form of intervals can be determined using an ensemble of predictive models obtained through a machine learning model aggregation technique of the present principles. Resulting prediction intervals can be directly interpreted by project stakeholders and stored for use in, for example, budgeting, planning and forecasting of projects. The stored results/prediction intervals of a PAE of the present principles can then be used with an APM system to, for example:
1) determine and optimally adjust a remaining budget or schedule of a portfolio of projects given a shared budget constraint;
2) optimally select a subset of projects for execution from a set of proposed projects, where the selected set of projects presents an optimal trade-off between cost and benefits, while satisfying shared budget, and scheduling constraints;
3) establish support for budget and schedule proposals;
4) perform project management scheduling activities such as: Program evaluation and review technique (PERT) for planning multiple projects with dependent schedules; and
5) generate human-readable reports.

In all such embodiments, determined PAE intervals can also serve to perform best/worst/average case analysis. That is, each of the above-described case-analyses can be performed by considering certain properties of the PAE intervals for each project. For example, in some embodiments, a maximum cost and longest schedule can be selected from a determined PAE interval to analyze the worst case of both cost and schedule. Conversely, in some embodiments, a minimum cost and shortest schedule can be selected from a determined PAE interval to analyze the best case of both cost and schedule.

In some embodiments a PAE system of the present principles provides a weighted ensemble of predictive models produced through automated machine learning that adapts automatically to the project's data distribution to make accurate project cost and schedule estimates without overfitting. Afterwards, a corresponding weighted average of models can be used to estimate prediction intervals that represent project cost variances.

In some embodiments, the project cost and schedule estimates and variances can be used as inputs for a Monte-Carlo simulation if represented as parameters of continuous probability distributions, such as normal, Weibull, or triangular distribution (3-point estimate) for estimating other dependent variables. Alternatively or in addition, as described above, the project cost and schedule estimates and variances can be used with a variety of APM algorithms and systems.

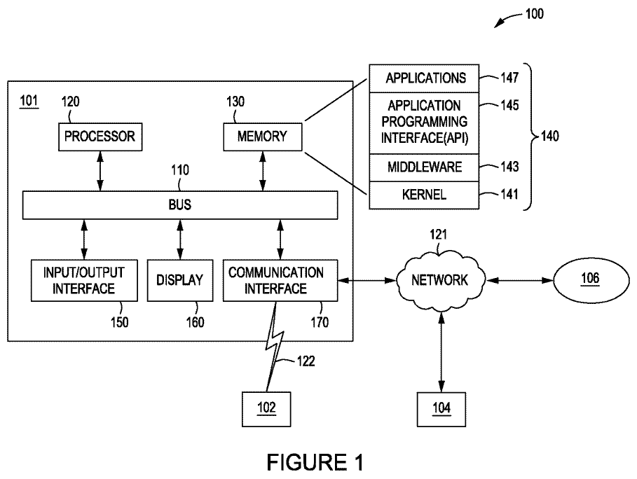

FIG. 1 depicts a high-level block diagram of a PAE system 100 embodied in a computing device 101 (e.g., desktop computer, PC, mobile phone, laptop, server, cloud-based server, or other suitable computing device) that is configured to operate in a network environment in accordance with an embodiment of the present principles. The computing device 101 includes a bus 110, a processor 120, a memory 130, an input/output device 150, a display 160, and a communication interface 170. In alternate embodiments, in a PAE system 100 of the present principles, at least one of the above-described components of the computing device can be omitted or additional components can be further included in the computing device 101 without departing from the scope of the present principles.

In some embodiments, the bus 110 of FIG. 1 can be a circuit connecting at least the processor 120, the memory 130, the input/output device 150, the display 160, and the communication interface 170 and transmitting communications (e.g., control messages and/or data) between at least the above-described components.

In some embodiments, the processor 120 can include one or more of a CPU, an application processor (AP), and/or a communication processor (CP). The processor 120 controls at least one of the other components of the computing device 101 and/or processing data or operations related to communication. The processor 120, for example, can use one or more control algorithms, which can be stored in the memory 130, to perform a method for project cost and schedule estimation, as will be described in greater detail below.

The memory 130, which can be a non-transitory computer readable storage medium, can include volatile memory and/or non-volatile memory. The memory 130 stores data or commands/instructions related to at least one of other components of the computing device 101. The memory 130 stores software and/or a program module 140. For example, the program module 140 can include a kernel 141, middleware 143, an application programming interface (API) 145, application programs (or applications) 147, etc. The kernel 141, the middleware 143 or at least part of the API 145 can be considered an operating system (OS). Although in the embodiment of FIG. 1, the memory is illustratively a component of the computing device 101, in some embodiments, a PAE system of the present principles can alternatively or in addition include a storage device/memory (not shown) external of the computing device 101.

In the embodiment of the PAE system 100 of FIG. 1, the kernel 141 controls or manages system resources (e.g., the bus 110, the processor 120, the memory 130, etc.) used to execute operations or functions of other programs (e.g., the middleware 143, the API 145, and the applications 147). The kernel 141 provides an interface capable of enabling the middleware 143, the API 145, and the applications 147 to access and control/manage the individual components of the computing device 101, e.g., when performing a project cost and schedule routine and/or operation.

In the embodiment of FIG. 1, the middleware 143 can be an interface between the API 145 or the applications 147 and the kernel 141 so that the API 145 or the applications 147 can communicate with the kernel 141 and exchange data therewith. The middleware 143 processes one or more task requests received from the applications 147 according to a priority. For example, the middleware 143 assigns a priority for use of system resources of the computing device 101 (e.g., the bus 110, the processor 120, the memory 130, etc.) to at least one of the applications 147. For example, the middleware 143 processes one or more task requests according to a priority assigned to at least one application program, thereby performing scheduling or load balancing for the task requests. For example, when executing the applications 147, which can include a project cost and schedule estimation process (e.g., managing local and remote-shared data-sources, guiding the user in data preparation, and applying statistical and Artificial Intelligence analysis), different priorities can be assigned to one or more tasks of the asset reliability model creation application so that a task having a higher priority can be performed prior to a task having a lower priority, e.g., storing data input by a user can have a relatively high priority, while updating information of an asset in a database of the memory 130 can have a relatively low priority.

The API 145 can include an interface that is configured to enable the applications 147 to control functions provided by the kernel 141 or the middleware 143. The API 145 can include at least one interface or function (e.g., instructions) for file control, window control, image process, text control, or the like.

The input/output device 150 is capable of transferring instructions or data, received from the user or one or more remote (or external) electronic devices 102, 104 or the server 106, to one or more components of the computing device 101. For example, the input/output device 150 can receive an input, e.g., entered via the display 160, a keyboard, or verbal command, from a user. The input can include information, e.g., a user selection of a set of local and/or remote-shared data sources, or a user selection of a type of real-world event that the user wants to model.

In the embodiment of FIG. 1, the input/output device 150 is capable of outputting instructions or data, which can be received from one or more components of the computing device 101, to the user or remote electronic devices.

The display 160 can include a liquid crystal display (LCD), a flexible display, a transparent display, a light emitting diode (LED) display, an organic LED (OLED) display, micro-electromechanical systems (MEMS) display, an electronic paper display, etc. The display 160 displays various types of content (e.g., texts, images, videos, icons, symbols, etc.). The display 160 can also be implemented with a touch screen. In this case, the display 160 receives touches, gestures, proximity inputs or hovering inputs, via a stylus pen, or a user's body.

The communication interface 170 establishes communication between the computing device 101 and the remote electronic devices 102, 104 or a server 106 (which can include a group of one or more servers and can be a cloud-based server) connected to a network 121 via wired or wireless communication. In accordance with the present principles, the computing device 101 can include cloud computing, distributed computing, or client-server computing technology when connected to the server 106.

Wireless communication can include, as cellular communication protocol, at least one of long-term evolution (LTE), LTE Advance (LTE-A), code division multiple access (CDMA), wideband CDMA (WCDMA), universal mobile telecommunications system (UMTS), wireless broadband (WiBro), and global system for mobile communication (GSM), which can be used for global navigation satellite systems (GNSS). The GNSS may include a global positioning system (GPS), global navigation satellite system (Glonass), Beidou GNSS (Beidou), Galileo, the European global satellite-based navigation system, according to GNSS using areas, bandwidths, etc. Wireless communication may also include short-range communication 122. Short-range communication may include at least one of wireless fidelity (Wi-Fi), Bluetooth (BT), near field communication (NFC), and magnetic secure transmission (MST).

Wired communication may include at least one of universal serial bus (USB), high definition multimedia interface (HDMI), recommended standard 232 (RS-232), and plain old telephone service (POTS). The network 121 can include at least one of the following: a telecommunications network, e.g., a computer network (e.g., local area network (LAN) or wide area network (WAN)), the Internet, and a telephone network.

Each of the remote electronic devices 102 and 104 and/or the server 106 can be of a type identical to or different from that of the electronic device 101. All or some of the operations performed in the computing device 101 can be performed in the remote electronic devices 102, 104 or the server 106. When the computing device 101 has to perform some functions or services automatically or in response to a request (e.g., when using the asset management application), the computing device 101 can make a request for performing at least some functions relating thereto to the remote electronic device 102 or 104 or the server 106, instead of performing the functions or services by itself. The remote electronic devices 102, 104 or the server 106 can execute the requested functions or the additional functions and can deliver a result of the execution to the computing device 101. The computing device 101 can provide the received result as it is or additionally process the received result and provide the requested functions or services. To achieve this, for example, cloud computing, distributed computing, or client-server computing technology can be used.

A Project Attribute Estimator (ensemble) model creation application (e.g., the application 147) includes a plurality of instructions that are executable by the processor 120 using the API 145. The application can be downloaded from the server 106 (or the remote electronic device 104) via the Internet over the network 121 (or from the remote electronic device 102 via, for example, the short-range communication 122) and installed in the memory 130 of the computing device 101. Although the computing device 101 is depicted as a general purpose computer, the computing device 101 is programmed to perform various specialized control functions and is configured to act as a specialized, specific computer in accordance with the present principles, and embodiments can be implemented in hardware, for example, as an application specified integrated circuit (ASIC). As such, the process steps described herein are intended to be broadly interpreted as being equivalently performed by software, hardware, or a combination thereof.

In some embodiments of the present principles, a PAE system of the present principles, such as the PAE system 100 of FIG. 1, can implement at least one machine learning process for interpreting received information/data (e.g., project cost and schedule data) for determining an ensemble of models in accordance with the present principles. For example, in some embodiments of the present principles, the software and/or program module 140 can include a machine learning (ML) process (not shown) to evaluate and apply project data information for use in determining an ensemble of models in accordance with the present principles. In some embodiments, the ML process can include a multi-layer neural network comprising nodes that are trained to have specific weights and biases. In some embodiments, the ML process of, for example, the software and/or program module 140 employs artificial intelligence techniques or machine learning techniques to analyze project data to determine at least cost and schedule models for a plurality of projects. That is, in some embodiments, in accordance with the present principles, suitable machine learning techniques can be applied to learn commonalities in sequential application programs and for determining from the machine learning techniques at what level sequential application programs can be canonicalized. In some embodiments, machine learning techniques that can be applied to learn commonalities in sequential application programs can include, but are not limited to, regression methods, ensemble methods, or neural networks and deep learning such as ‘Se2oSeq’ Recurrent Neural Network (RNNs)/Long Short Term Memory (LSTM) networks, Convolution Neural Networks (CNNs), graph neural networks applied to the abstract syntax trees corresponding to the sequential program application, and the like. In some embodiments a supervised ML classifier could be used such as, but not limited to, Multilayer Perceptron, Random Forest, Naive Bayes, Support Vector Machine, Logistic Regression and the like.

The ML process can be trained using thousands to millions of instances of project related data and respective features (e.g., cost and scheduling project data and features) to be used to generate models that can be compiled as an ensemble of models in accordance with the present principles. Over time, the ML process learns to look for specific attributes in the project data to determine an ensemble of models in accordance with the present principles.

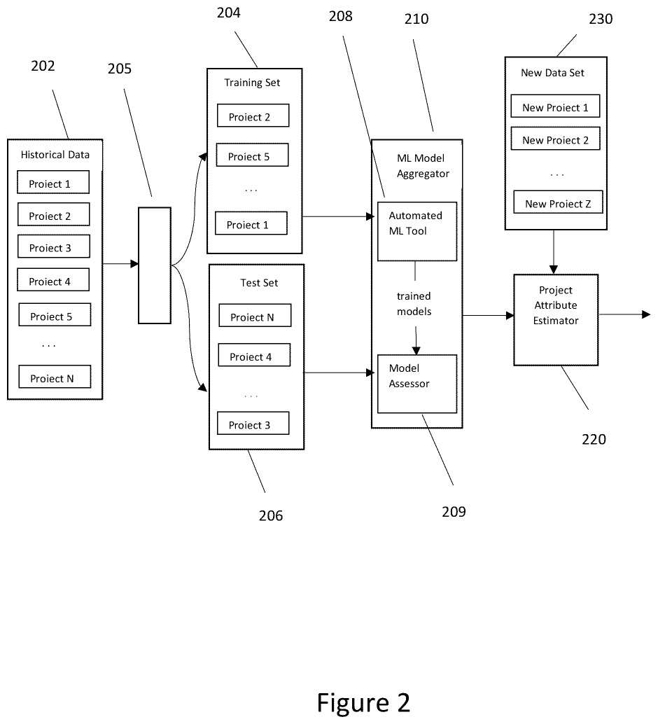

FIG. 2 depicts a graphical representation of the functionality of a PAE system of the present principles, such as the PAE system 100 of FIG. 1 in accordance with an embodiment of the present principles. In the embodiment of FIG. 2, the PAE system comprises a data separation module 205, a machine learning (ML) model aggregator module 210, and a project attribute estimator module 220. In the PAE of the embodiment of FIG. 2, the ML model aggregator module 210 includes an Automated ML Tool 208 and a model assessor module 209.

In the embodiment of FIG. 2, the Historical Data 202 comprises N completed project records with project-related features and numerical project cost and schedule labels, for example, stored, in some embodiments, in an accessible storage (not shown). The Historical Data 202 can include data of at least one project, for example, at various stages of the project. For example, a construction project can include multiple stages, including but no limited to, the pouring a foundation, installing a roof, wiring electrical, installing flooring, painting, installing appliances and fixtures and many more. Each of the stages can be associated with respective project information, such as the cost of each stage of the project and the amount of time required to complete each stage. In accordance with the present principles, an amount of detail (i.e., stages) for each project can be dependent upon a granularity desired in machine learning models trained and generated using the Historical Data 202. For example, in a roofing example, the roofing project stage can be further detailed to include different stages of the roofing project stage, for example, a tear down of the old roof, a tarping of the roof, an installation of new shingles, etc. In various embodiments, the Historical Data 202 can include such data (e.g., cost and schedule data) for a plurality of projects of different kinds and having different stages.

In various embodiments and as depicted in the embodiment of FIG. 2, the Historical Data 202 can be repeatedly split into a Training Data Set 204 and a Testing Data Set 206 by the data separation module 205. For example, in the embodiment of FIG. 2, the Historical Data Set 202 contains n completed projects (data rows), each of which can be described by features and a label (in the project case of FIG. 2, cost and/or schedule labels and respective features). The Historical Data Set 202 is received by the data separator module 205 and is repeatedly split into a Training Data Set 204 and a Test Data Set 206. The split size and records distribution for the projects of the Historical Data Set 202 can be automated in the data separator module 205 through a random stratification or grouping of records which preserves the original data shape and main characteristics in both the Training Data Set 204 and the Test Data Set 206. In some embodiments the data sets can be split by the data separator module 205 to have 70% of all data in the Training Data Set 204 and 30% of all data in the Test Data Set 206. In some embodiments a bootstrapping sampling method can be used by the data separator module 205 to repeatedly split the Historical Data Set, such as with the “0.632+ estimator” (Hastie, Tibshirani, Friedman, 2008) method, so that each generated model in a Generated Ensemble of Models of the present principles is trained on a different bootstrapped training data set generated from the Historical Data Set 202. Although in the embodiment of FIG. 2, the data separator module 205 is depicted as a separate component, in some embodiments of the present principles, the separator module 205 can comprise an integrated component of the ML model aggregator 210.

In some embodiments, the multiple Training Data Sets 204 determined from the Historical Data Set 202 by the data separation module 205 can be communicated to the ML Model Aggregator 210. Alternatively or in addition, the ML Model Aggregator 210 of the present principles can receive multiple training data sets from other sources, such as a user of the PAE system of the present principles or from a storage device accessible to the PAE system of the present principles. Using the training data sets, the ML Model Aggregator 210 can generate at least one ML model for each of the generated training sets. The ML Model Aggregator 210 can compile the generated ML models to generate an ensemble of ML models for determining project attributes, for example, cost and schedule attributes, of projects of, for example, the New Data Set 230 of FIG. 2 using a respective training data set determined from the projects of the Historical Data Set 202. That is, in some embodiments, the ML Model Aggregator 210 can iteratively employ the Automated ML Tool 208 to generate ML models, with optimal hyper-parameters if applicable, for generating training data sets for the Training Data Sets 204. For each repetition, respectively determined training data sets of the Training Data Sets 204 can be used to train a respective ML model. The ML Automated ML Tool 208 can then stop processing, for example, after a pre-determined time or when the average performance of the generated ensemble of cost and schedule models has not improved in at least one last training iteration. In some embodiments, the distribution of predictions produced by the ML models generated from the training data for a given project, serves to estimate robust and unbiased prediction intervals, for example, by taking the 5^{th}, 50^{th} and 95^{th} percentile of the cost and schedule predictions for a respective project (described in greater detail below).

Specifically and as depicted in the embodiment of FIG. 2, historical data related to at least one previous performance of a same or a similar project as the at least one new project of the New Data Set 230 for which at least one range of project attribute values were to be determined can be received by the data separation module 205. In the embodiment of FIG. 2, the historical data can include historical project attribute values of the at least one project attribute. The separation module 205 of FIG. 2 generates multiple training data sets, each of the training data sets including at least some different historical project attribute values as in other training data sets. As depicted in the embodiment of FIG. 2, the multiple training data sets of the Training Data Sets 204 determined, in some embodiments, by the data separation module 205 from the Historical Data Set 202, can be communicated to the ML Model Aggregator 210.

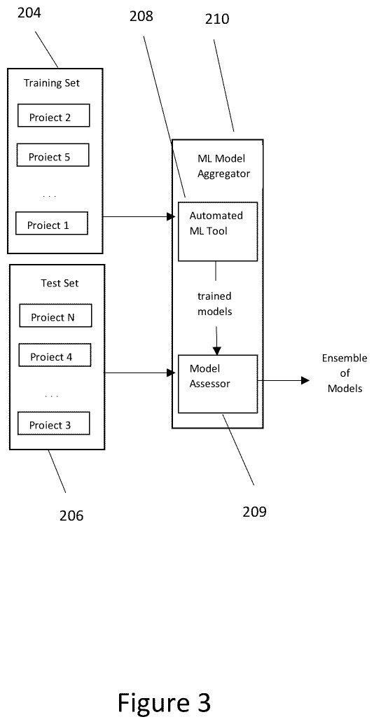

FIG. 3 depicts a graphical representation of a more detailed description of the functionality of the ML Model Aggregator 210 of FIG. 2 in accordance with an embodiment of the present principles. As depicted in the embodiment of FIG. 3, at the ML Model Aggregator 210, the Training Data Sets 204 can be received by the Automated ML Tool 208. In the embodiment of FIG. 3, the Automated ML Tool 208 computes an ML model, referred to herein as a Generated Model, for each training set of the Training Data Sets 204 of project data determined from the Historical Data Set 202, for example, via a sampling technique, such as a bootstrapping or another method as described above. In some embodiments, for each of the training sets, the Automated ML Tool 208 finds a best combination of machine learning models with at least one of optimal hyper-parameters, Data Pre-processor Script, and/or Feature Selector Script, and outputs the combination as Generated Models for further use by the ML Model Aggregator 210. In some embodiments of the present principles, the Automated ML Tool 208 can construct a pipeline (defined combination) that maximizes the fitting score and/or minimizes the fitting error on a respective one of the training data sets of the Training Data Sets 204. In some embodiments, the model generation process of the Automated ML Tool 208 can end after a predetermine duration or by meeting certain conditions on the entropy of the Mean Label or Fit Score and/or error.

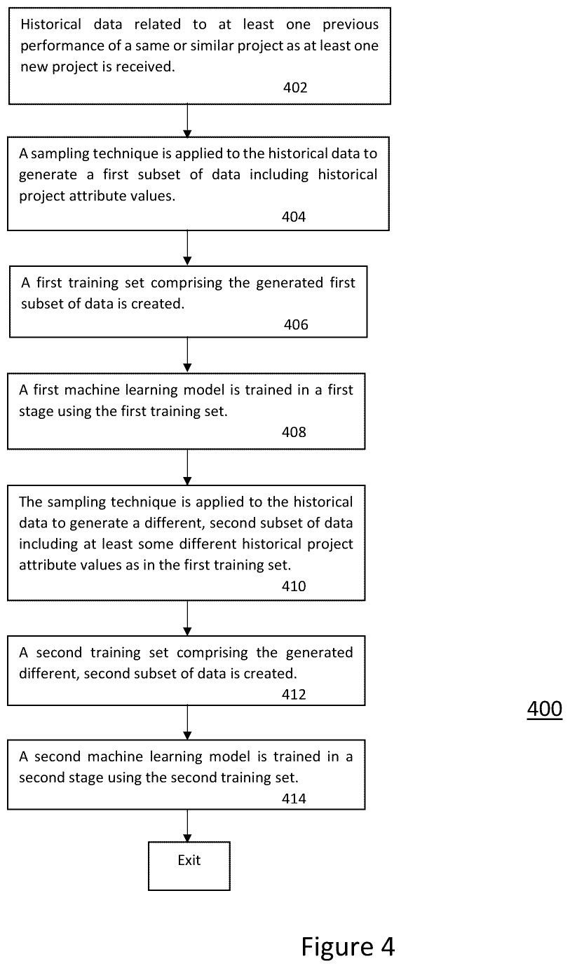

FIG. 4 depicts a flow diagram of a method 400 for generating/training multiple respective machine learning models using different sets of training data determined from historical data, each of the different sets of the training data being used to train a respective one of the machine learning models in accordance with an embodiment of the present principles. The method 400 can begin at 402 during which historical data related to at least one previous performance of a same or similar project as at least one new project is received. In some embodiments, the historical data can include historical project attribute values of the at least one project attribute of the new project. The method 400 can proceed to 404.

At 404, a sampling technique is applied to the historical data to generate a first subset of data including historical project attribute values. The method 400 can proceed to 406.

At 406, a first training set comprising the generated first subset of data is created. The method 400 can proceed to 408.

At 408, a first machine learning model is trained in a first stage using the first training set. The method 400 can proceed to 410.

At 410, the sampling technique is applied to the historical data to generate a different, second subset of data including at least some different historical project attribute values as in the first training set. The method 400 can proceed to 412.

At 412, a second training set comprising the generated different, second subset of data is created. The method 400 can proceed to 414.

At 414, a second machine learning model is trained in a second stage using the second training set. The method 400 can be exited.

In some embodiments, the method 400 can further include applying the sampling technique to the historical data to generate at least a third, different subset of data including at least some different historical project attribute values as in the first training set and the second training set, creating at least a third training set comprising the generated different, at least the third subset of data, and training at least a third machine learning model in at least a third stage using the at least the third training set.

Referring back to FIG. 3 and as depicted in the embodiment of FIG. 3, in the ML Model Aggregator 210, the Generated Models from the Automated ML Tool 208 can be communicated to the model assessor module 209. In some embodiments of the present principles, in the ensemble model assessor module 209 fitting score or error results of the multiple generated models can be evaluated by functions that compare predicted values with the labeled ones. In some embodiments of the present principles, examples of score or error functions can include, but are not limited to, adjusted R2, Mean Square Error, and Mean Absolute Error. More specifically, in some embodiments after ith Generated Model, M_i, is generated by the Automated ML Tool 208, the ML Model Aggregator 210 employs the model assessor module 209 to determine whether or not to stop generating models. The model assessor module 209 evaluates and scores the ith Generated Model, M_i, (with a pre-selected metric such as adjusted R2, Mean Squared Error, Mean Absolute Error) by analyzing its predictions on Test Set I (standard ML validation techniques). The mean score S_i of the first i models, M_1, . . . , M_i, is compared to the mean score S_{i−1} of the first i−1 models. If S=|S_i−S_{i−1}| is below some threshold S_{stop}, then models M_1, . . . , M_i, are outputted by the ML Model Aggregator 210 as an Ensemble of Models. Otherwise, the ML Aggregator 210 proceeds with iteration i+1. Alternatively or in addition, in some embodiments model assessor module 209 uses a mean predicted value, instead of the mean score, in the same way as described above.

More specifically, in the embodiment of FIG. 3, in a testing step, each of the computed best-fit model, referred to as Generated Model i, can be iteratively tested on a selected Test Set i of the Test Set 206 by the model assessor module 209 to associate a fitting score or error on the test data that was not utilized during the fitting process. For regression algorithms, mean cost value can also be saved. The process of the ML Aggregator 210 can then return to computing the best-fit model/pipeline on another selected training set i of the Training Sets 204 of records picked from the Historical Data Set 202 and, as described above, the process can be repeated for a minimal predefined number of iterations and can stop when the average of the mean cost or schedule values are no longer changing (within a threshold interval) with each new iteration.

To reiterate, in some embodiments of the present principles, the generated model(s) determined by the Automated ML Tool 208 of the ML Model Aggregator 210 can be assessed using the Testing Data Set 206 to estimate a predictive performance of the generated model(s). For example, the generated model(s) can be assessed via the ensemble model assessor module 209, which can apply the Testing Data Set 206 to the generated models to determine an effectiveness of the generated model(s). A threshold can be set and any generated model that performs above the set threshold can be included in a set of assembled models that can be used to estimate a project cost and/or schedule in accordance with the present principles.

In some embodiments, the output produced by an ML Model Aggregator of the present principles, such as the ML Model Aggregator 210, can include a weighted ensemble of predictive models of project attributes, such as project cost estimates and/or project schedule estimates, for example in some embodiments, for each stage of a plurality of projects. A weighting of predictive models can be used, for example, to relate the specific function and/or strength of each model to features of projects. For example, a project that is at stage 1 might be better predicted with one model, called Model A and the project that is at stage 2 might be better predicted with another model, called Model B. As such, predictions obtained from the ensemble of models, {Model A, Model B} can be weighted so that the predictions of Model A carry more weight for projects at stage 1 and the predictions of Model B carry more weight for projects at stage 2. In some embodiments of the present principles, each of the models of the generated ensemble of predictive models can be weighted to determine an importance of each generated model in relation to one or more features, such as project stages, of projects that comprise a portfolio of projects. That is, in some embodiments, a group of projects for which an ensemble of models is determined in accordance with the present principles can comprise a portion of a total portfolio of projects and, as such, the ensemble of models determined for the group of projects can be weighted to assign an importance of the ensemble of models determined for the group of projects to a total portfolio of projects. In some embodiments of the present principles, weights can be selected by an ML Aggregator of the present principles, such as the ML Model Aggregator 210, in a validation phase by analyzing the accuracy of each model in relation to the features of a respective project. Models that score highly in the validation phase for a set of projects whose features have specific or similar properties will be weighted highly for predicting on similar projects. The most important features of a respective project will have the greatest effect on model weighting.

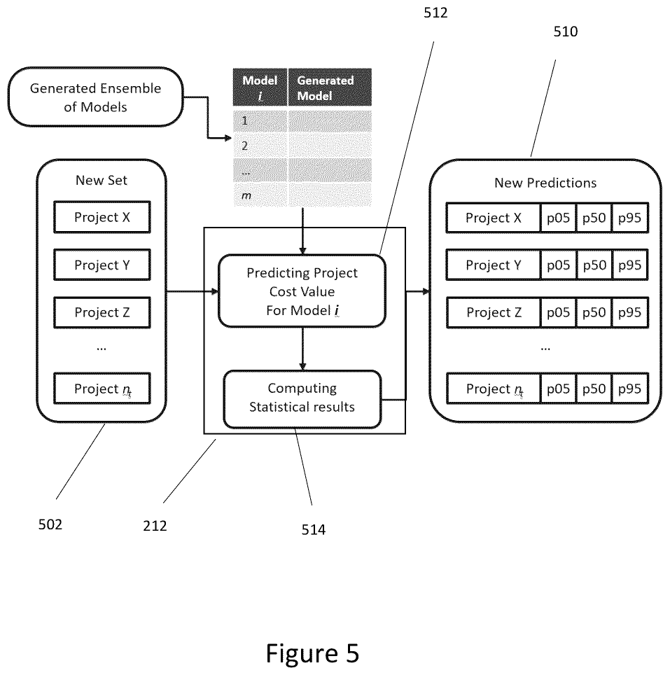

Referring back to FIG. 2, the ensemble of models generated by the ML Aggregator module 210 can be communicated to the Project Cost and Estimator module 212. FIG. 5 depicts a graphical representation of a functionality of the Project Attribute Estimator 212 of FIG. 2 in accordance with an embodiment of the present principles. In the embodiment of FIG. 5, the Project Attribute Estimator 212 receives as inputs, a New Data Set 502 comprising project data for projects X, Y, Z, . . . n, for which project attribute value estimate ranges, such as cost estimates and/or schedule estimates, are to be determined using the ensemble of models determined, as described above, by an ML Aggregator of the present principles, such as the ML Aggregator 210 of FIG. 2. In the embodiment of FIG. 5, the New Data Set 502 contains nₜ incomplete projects with features but without labels (e.g., cost or schedule). The project features of the New Data Set 502 of FIG. 5 can include numerical values defining record attributes including, but not limited to: Categorical; such as describing an event order: 1—New, 2—Processing, and 3—Completed: Binary; a special case of the above with either True/False values: Count; Positive integer values that frequently follow a Poisson distribution: and Interval; Decimal values such a cost represented in dollars or other units.

As depicted in the embodiment of FIG. 5, a project attribute estimator of a PAE system of the present principles, such as the project attribute estimator 220 of the PAE system 100 of FIGS. 1 and 2, includes a mean project attribute estimator 512. The mean project attribute estimator 512 receives the ensemble of models determined by the ML Aggregator 210. For each project/project stage of the New Data Set 502, X, Y, Z, . . . n, the mean project attribute estimator 512 of the Project Attribute Estimator 212 applies the ensemble of models to predict project attribute value ranges, such as cost range value estimates and/or schedule range value estimates. That is, the mean project attribute estimator 512 applies the ensemble of ML models to the project data of the New Data Set 502 to predict at least one project attribute value range estimates for each of the projects X, Y, Z, . . . n, of the New Data Set 502. That is, in some embodiments, the mean project attribute estimator 512 determines a range of values for the at least one project attribute of at least one new project of the New Data Set 502 by applying the multiple respective machine learning models to the at least one project attribute of the new project

As depicted in the embodiment of FIG. 5, a project attribute estimator of a PAE system of the present principles, such as the project attribute estimator 220 of the PAE system 100 of FIGS. 1 and 2, includes an optional prediction interval estimator 514. In the embodiment of FIG. 5, the prediction interval estimator 514 receives the predicted project attribute values from the mean project attribute estimator 512 of the project attribute estimator 220 and in some embodiments determines statistics, such as mean/standard deviation or percentile results, on the cost and/or schedule range estimate values. In some embodiments, the prediction interval estimator 514 can determine prediction intervals from the statistics determined from received project attribute value ranges. For example, in the embodiment of FIG. 5, the prediction interval estimator 514 determines cost and schedule range estimates using the 5^{th}, 50^{th}, and 95^{th} percentile of the prediction estimates for each of the projects of the New Data Set 502, essentially providing a substantially best case cost and/or schedule estimate, a worst case cost and/or schedule estimate and a mean cost and/or schedule estimate. That is, in some embodiments, prediction intervals (e.g., percentile values for the prediction estimates) can be determined based values of the received data. Alternatively or in addition, prediction interval information can be received from a user of a PAE system of the present principles. In the embodiment of FIG. 5, resultant project attribute range values determined using the three sample percentiles serve as the overall New Predictions 510 for the projects of the New Data Set 502.

In some embodiments of the present principles, determined estimates (e.g., cost estimates and schedule estimates) and prediction intervals output from a PAE system of the present principles, such as the PAE system 100 of FIG. 1, can be used as inputs to several algorithms, processes, and reports, including an APM system, to assist in, for example, determining and optimally adjusting an overall budget or schedule of a portfolio of projects given shared budget and/or schedule constraints. In addition, a PAE system of the present principles can be part of a resource allocation system that either directly allocates or schedules physical or financial resources to a project and/or portfolio of projects based on determined project attribute value ranges determined by a PAE system of the present principles. In such embodiments, a portfolio owner controls a portfolio of projects that either are planned for execution or are being executed within a certain planned budget and schedule constraint. The output of a PAE system of the present principles, in some embodiments, can show some discrepancy between the planned budget and schedule and a predicted budget and schedule. The predictions can be used to adjust the budget and schedule for the remainder of a planned execution. Such adjustments, if permitted, can be made directly to the constraints, or otherwise by can be accomplished by adjusting (changing, cutting, or adding) the planned projects themselves by competing them against one-another, and perhaps with additional unplanned projects, in an optimizer, using the predicted costs and schedules as inputs. A selected set of projects can present an optimal trade-off between cost and benefits, while satisfying shared budget, and scheduling constraints.

For example, scheduled projects can get delayed and organizations can end up underspending in the earlier part of their plans only to overspend during the latter part of their plans. Embodiments of PAE system in accordance with the present principles create a more accurate prediction of project attribute value ranges as described above. As such, project attribute valued ranges predicted by a PAE system of the present principles can be compared with previously determined budgets to determine an underspend and/or overspend condition. More specifically, if an overspend is being predicted, a portfolio manager/resource allocation system can reduce a number of or slow down projects or increase budget. If an underspend is being predicted, a portfolio manager/resource allocation system can over schedule and start more projects, get more projects ready to ‘fill in,’ or decrease budget. If a delay is predicted, a portfolio manager/resource allocation system can properly update/set expectations on when projects will be realistically completed.

Embodiments of a PAE system in accordance with the present principles can be implemented to address at least the following problems: a) paying interest on funds that didn't get spent; b) having difficulties obtaining similar funding levels in the future; and c) negative public perception. In summary, a PAE system in accordance with the present principles can assist a portfolio manager/resource allocation system to proactively reallocate funds and resources for reaching targets.

The determination of budgets and schedules can include an iterative process that requires multiple rounds of discussion and approvals. Determined PAE predictions and intervals introduce data into a determination process, such that decisions depend less on intuition and more on data analysis. As such, a determination process can be shortened and the accountability for decisions is partially offloaded from individuals onto a data analysis process of the present principles.

I some embodiments a PAE system of the present principles can be implemented to predict a range of values for at least one project attribute using at least historical performance information of the at least one project attribute and such information can be used to update a resource allocation schedule that was determined based on an expected performance of the at least one project attribute based on a comparison between the predicted range of values for the at least one project attribute and the expected performance of the at least one project attribute. Resources for the performance of the at least one project attribute can be allocated based on the updated resource allocation schedule.

For resource allocation, a dependent schedule occurs when one project, or a part of a project, must be completed to a point before another project can be started. A delay in the earlier project will delay the dependent project. In such instances, if there are many projects with complex dependencies and deadlines for the completion of certain milestones, project managers implement techniques to analyze how individual project schedules could affect the overall schedule. One such technique is a Program evaluation and review technique (PERT), which uses a probability distribution for each project's completion time. In such embodiments, the schedule predictions and intervals, as well as project dependencies, serve as inputs to PERT. The portfolio owner can therefore use a PAE system of the present principles in conjunction with a PERT technique/system (or some other technique) to periodically analyze and adjust the execution plan for the projects.

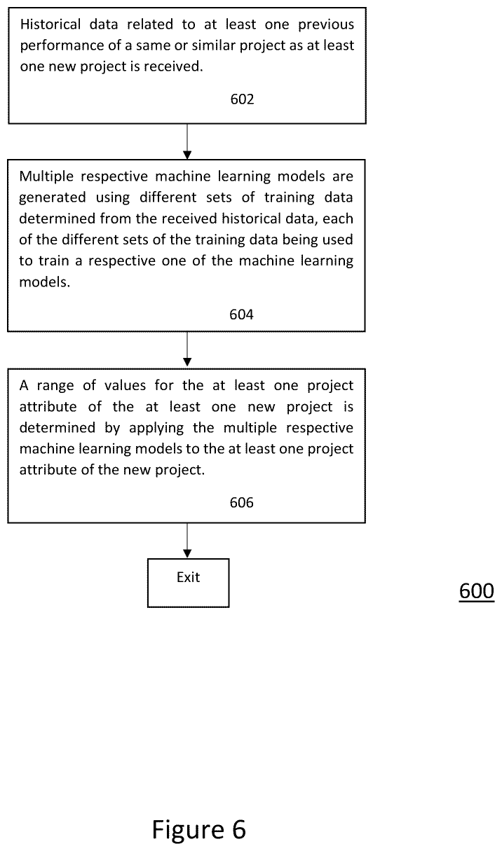

FIG. 6 depicts a flow diagram of a method 600 for determining project attribute range values for at least one project attribute of at least one new project, in accordance with an embodiment of the present principles. The method 600 begins at step 602 during which historical data related to at least one previous performance of a same or similar project as the at least one new project is received, the historical data including historical project attribute values of the at least one project attribute. The method 600 can proceed to 604.

At 604, multiple respective machine learning models are generated using different sets of training data determined from the received historical data, each of the different sets of the training data being used to train a respective one of the machine learning models. The method 600 can proceed to 606.

At step 606, a range of values for the at least one project attribute of the at least one new project is determined by applying the multiple respective machine learning models to the at least one project attribute of the new project. The method 600 can be exited.

In some embodiments, the method 600 can further include determining the different sets of training data from the received historical data by repeatedly applying a sampling technique to the historical data.

In some embodiments, the method 600 can further include applying testing data to the generated multiple machine learning models to determine a validity of the multiple machine learning models, wherein only ones of the multiple machine learning models determined to be valid are applied to the at least one project attribute of the new project to determine a range of values for the at least one project attribute of the at least one new project.

In some embodiments, the method 600 can further include determining a prediction interval and determining the range of values for the at least one project attribute of the at least one new project in accordance with the determined prediction interval.

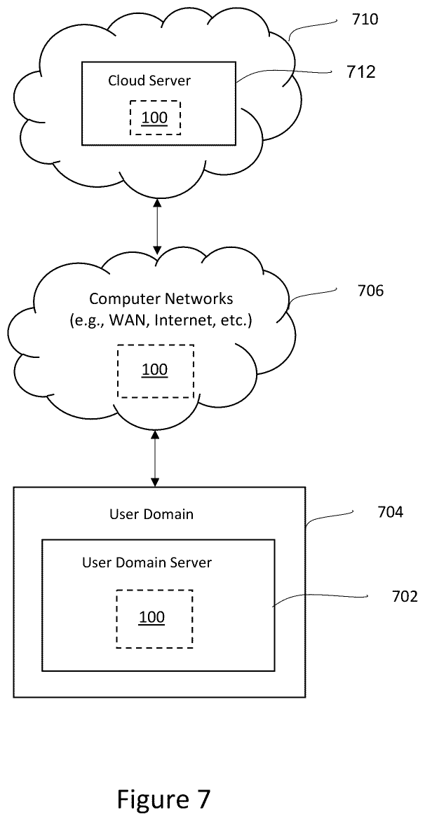

FIG. 7 depicts a high-level block diagram of a network in which embodiments of a PAE system in accordance with the present principles, such as the PAE system 100 of FIG. 1 and the PAE system of FIG. 2, can be applied in accordance with an embodiment of the present principles. The network environment 700 of FIG. 7 illustratively comprises a user domain 702 including a user domain server/computing device 704. The network environment 700 of FIG. 7 further comprises computer networks 706, and a cloud environment 710 including a cloud server/computing device 712.

In the network environment 700 of FIG. 7, a system for determining project attribute range values for at least one project attribute of at least one new project in accordance with the present principles, such as the PAE system 100 of FIG. 1, can be included in at least one of the user domain server/computing device 704, the computer networks 706, and the cloud server/computing device 712. That is, in some embodiments, a user can use a local server/computing device (e.g., the user domain server/computing device 704) to determine project attribute range values for at least one project attribute of at least one new project in accordance with the present principles.

In some embodiments, a user can implement a system for determining project attribute range values for at least one project attribute of at least one new project in the computer networks 706 to provide project attribute range values for at least one project attribute of at least one new project in accordance with the present principles. Alternatively or in addition, in some embodiments, a user can implement a system for determining project attribute range values for at least one project attribute of at least one new project in the cloud server/computing device 712 of the cloud environment 710 to provide project attribute range values for at least one project attribute of at least one new project. For example, in some embodiments it can be advantageous to perform processing functions of the present principles in the cloud environment 710 to take advantage of the processing capabilities and storage capabilities of the cloud environment 710. In some embodiments in accordance with the present principles, a system for determining project attribute range values for at least one project attribute of at least one new project can be located in a single and/or multiple locations/servers/computers to perform all or portions of the herein described functionalities of a system in accordance with the present principles. For example, in some embodiments some components of a PAE system of the present principles can be located in one or more than one of the a user domain 702, the computer network environment 706, and the cloud environment 710 while other components of the present principles can be located in at least one of the user domain 702, the computer network environment 706, and the cloud environment 710 for providing the functions described above either locally or remotely.

Those skilled in the art will also appreciate that, while various items are illustrated as being stored in memory or on storage while being used, these items or portions of them can be transferred between memory and other storage devices for purposes of memory management and data integrity. Alternatively, in other embodiments some or all of the software components can execute in memory on another device and communicate with the illustrated computer system via inter-computer communication. Some or all of the system components or data structures can also be stored (e.g., as instructions or structured data) on a computer-accessible medium or a portable article to be read by an appropriate drive, various examples of which are described above. In some embodiments, instructions stored on a computer-accessible medium separate from the computing device 1101 can be transmitted to the computing device 101 via transmission media or signals such as electrical, electromagnetic, or digital signals, conveyed via a communication medium such as a network and/or a wireless link. Various embodiments can further include receiving, sending or storing instructions and/or data implemented in accordance with the foregoing description upon a computer-accessible medium or via a communication medium. In general, a computer-accessible medium can include a storage medium or memory medium such as magnetic or optical media, e.g., disk or DVD/CD-ROM, volatile or non-volatile media such as RAM (e.g., SDRAM, DDR, RDRAM, SRAM, and the like), ROM, and the like.

The methods and processes described herein may be implemented in software, hardware, or a combination thereof, in different embodiments. In addition, the order of methods can be changed, and various elements can be added, reordered, combined, omitted or otherwise modified. All examples described herein are presented in a non-limiting manner. Various modifications and changes can be made as would be obvious to a person skilled in the art having benefit of this disclosure. Realizations in accordance with embodiments have been described in the context of particular embodiments. These embodiments are meant to be illustrative and not limiting. Many variations, modifications, additions, and improvements are possible. Accordingly, plural instances can be provided for components described herein as a single instance. Boundaries between various components, operations and data stores are somewhat arbitrary, and particular operations are illustrated in the context of specific illustrative configurations. Other allocations of functionality are envisioned and can fall within the scope of claims that follow. Structures and functionality presented as discrete components in the example configurations can be implemented as a combined structure or component. These and other variations, modifications, additions, and improvements can fall within the scope of embodiments as defined in the claims that follow.

In the foregoing description, numerous specific details, examples, and scenarios are set forth in order to provide a more thorough understanding of the present disclosure. It will be appreciated, however, that embodiments of the disclosure can be practiced without such specific details. Further, such examples and scenarios are provided for illustration, and are not intended to limit the disclosure in any way. Those of ordinary skill in the art, with the included descriptions, should be able to implement appropriate functionality without undue experimentation.

References in the specification to “an embodiment,” etc., indicate that the embodiment described can include a particular feature, structure, or characteristic, but every embodiment may not necessarily include the particular feature, structure, or characteristic. Such phrases are not necessarily referring to the same embodiment. Further, when a particular feature, structure, or characteristic is described in connection with an embodiment, it is believed to be within the knowledge of one skilled in the art to affect such feature, structure, or characteristic in connection with other embodiments whether or not explicitly indicated.

Embodiments in accordance with the disclosure can be implemented in hardware, firmware, software, or any combination thereof. Embodiments can also be implemented as instructions stored using one or more machine-readable media, which may be read and executed by one or more processors. A machine-readable medium can include any mechanism for storing or transmitting information in a form readable by a machine (e.g., a computing device or a “virtual machine” running on one or more computing devices). For example, a machine-readable medium can include any suitable form of volatile or non-volatile memory.

Modules, data structures, and the like defined herein are defined as such for ease of discussion and are not intended to imply that any specific implementation details are required. For example, any of the described modules and/or data structures can be combined or divided into sub-modules, sub-processes or other units of computer code or data as can be required by a particular design or implementation.

In the drawings, specific arrangements or orderings of schematic elements can be shown for ease of description. However, the specific ordering or arrangement of such elements is not meant to imply that a particular order or sequence of processing, or separation of processes, is required in all embodiments. In general, schematic elements used to represent instruction blocks or modules can be implemented using any suitable form of machine-readable instruction, and each such instruction can be implemented using any suitable programming language, library, application-programming interface (API), and/or other software development tools or frameworks. Similarly, schematic elements used to represent data or information can be implemented using any suitable electronic arrangement or data structure. Further, some connections, relationships or associations between elements can be simplified or not shown in the drawings so as not to obscure the disclosure.

While the foregoing is directed to embodiments of the present disclosure, other and further embodiments of the disclosure may be devised without departing from the basic scope thereof.

What is claimed:

1. A method for determining project attribute range values for at least one project attribute of at least one new project, comprising:
receiving historical data related to at least one previous performance of a same or similar project as the at least one new project, the historical data including historical project attribute values of the at least one project attribute;
generating multiple respective machine learning models using different sets of training data determined from the received historical data, each of the different sets of the training data being used to train a respective one of the machine learning models; and
determining a range of values for the at least one project attribute of the at least one new project by applying the multiple respective machine learning models to the at least one project attribute of the new project.

2. The method of claim 1, wherein the at least one project attribute comprises at least one of a project cost or a project schedule.

3. The method of claim 1, further comprising:
determining the different sets of training data from the received historical data by repeatedly applying a sampling technique to the historical data.

4. The method of claim 1, further comprising:
applying testing data to the generated multiple machine learning models to determine a validity of the multiple machine learning models, wherein only ones of the multiple machine learning models determined to be valid are applied to the at least one project attribute of the new project to determine a range of values for the at least one project attribute of the at least one new project.

5. The method of claim 4, wherein the testing data comprises data of the historical data not used for training the multiple machine learning models, and wherein the historical data is separated into at multiple training datasets and at least one testing dataset using random stratification and grouping of records which preserves an original shape of the historical data and preserves main characteristics of the historical data.

6. The method of claim 1, further comprising:
weighting at least one of the at least one generated multiple machine learning models.

7. The method of claim 1, further comprising:
determining a prediction interval; and
determining the range of values for the at least one project attribute of the at least one new project in accordance with the determined prediction interval.

8. The method of claim 1, wherein an allocation of resources for the at least one project is based on the range of values determined for the at least one project attribute of the at least one new project.

9. A computer implemented method for training multiple respective machine learning models for determining a range of values for at least one project attribute of at least one new project, comprising:
receiving historical data related to at least one previous performance of a same or similar project as the at least one new project, the historical data including project attribute values of the at least one project attribute;
applying a sampling technique to the historical data to generate a first subset of data including historical project attribute values;
creating a first training set comprising the generated first subset of data;
training a first machine learning model in a first stage using the first training set;
applying the sampling technique to the historical data to generate a different, second subset of data including at least some different historical project attribute values as in the first training set;
creating a second training set comprising the generated different, second subset of data; and
training a second machine learning model in a second stage using the second training set.

10. The method of claim 9, further comprising:
applying the sampling technique to the historical data to generate at least a third, different subset of data including at least some different historical project attribute values as in the first training set and the second training set;
creating at least a third training set comprising the generated different, at least the third subset of data; and
training at least a third machine learning model in at least a third stage using the at least the third training set.

11. The method of claim 9, wherein the trained, multiple machine learning models are applied to the at least one project attribute of the new project to determine a range of values for the at least one project attribute of the at least one new project.

12. A non-transitory machine-readable medium having stored thereon at least one program, the at least one program including instructions which, when executed by a processor, cause the processor to perform a method in a processor-based system for determining project attribute range values for at least one project attribute of at least one new project, comprising:
receiving historical data related to at least one previous performance of a same or similar project as the at least one new project, the historical data including project attribute values of the at least one project attribute;
generating multiple respective machine learning models using different sets of training data determined from the received historical data, each of the different sets of the training data being used to train a respective one of the machine learning models; and
determining a range of values for the at least one project attribute of the at least one new project by applying the multiple respective machine learning models to the at least one project attribute of the new project.

13. The non-transitory machine-readable medium of claim 12, wherein the at least one project attribute comprises at least one of a project cost or a project schedule.

14. The non-transitory machine-readable medium of claim 12, wherein the method further comprises:
determining the different sets of training data from the received historical data by repeatedly applying a sampling technique to the historical data.

15. The non-transitory machine-readable medium of claim 12, wherein the method further comprises:
applying testing data to the generated multiple machine learning models to determine a validity of the multiple machine learning models, wherein only ones of the multiple machine learning models determined to be valid are applied to the at least one project attribute of the new project to determine a range of values for the at least one project attribute of the at least one new project.

16. The non-transitory machine-readable medium of claim 15, wherein the training data comprises data of the historical data not used for training the multiple machine learning models, and wherein the historical data is separated into at multiple training datasets and at least one testing dataset using random stratification and grouping of records which preserves an original shape of the historical data and preserves main characteristics of the historical data.

17. The non-transitory machine-readable medium of claim 12, wherein the method further comprises:
weighting at least one of the at least one generated multiple machine learning models.

18. The non-transitory machine-readable medium of claim 12, wherein the method further comprises:
determining a prediction interval; and
determining the range of values for the at least one project attribute of the at least one new project in accordance with the determined prediction interval.

19. The non-transitory machine-readable medium of claim 12, wherein an allocation of resources for the at least one project is based on the range of values determined for the at least one project attribute of the at least one new project.

20. A system for determining project attribute range values for at least one project attribute of at least one new project, comprising:
at least one data source;
a computing device comprising a processor and a memory having stored therein at least one program, the at least one program including instructions which, when executed by the processor, cause the computing device to perform a method, comprising:
receiving historical data related to at least one previous performance of a same or similar project as the at least one new project, the historical data including project attribute values of the at least one project attribute;
generating multiple respective machine learning models using different sets of training data determined from the received historical data, each of the different sets of the training data being used to train a respective one of the machine learning models; and
determining a range of values for the at least one project attribute of the at least one new project by applying the multiple respective machine learning models to the at least one project attribute of the new project.

21. The system of claim 20, wherein the at least one project attribute comprises at least one of a project cost or a project schedule.

22. The system of claim 20, wherein the method further comprises:
determining the different sets of training data from the received historical data by repeatedly applying a sampling technique to the historical data.

23. The system of claim 20, wherein the method further comprises:
applying testing data to the generated multiple machine learning models to determine a validity of the multiple machine learning models, wherein only ones of the multiple machine learning models determined to be valid are applied to the at least one project attribute of the new project to determine a range of values for the at least one project attribute of the at least one new project.

24. The system of claim 23, wherein the training data comprises data of the historical data not used for training the multiple machine learning models, and wherein the historical data is separated into at multiple training datasets and at least one testing dataset using random stratification and grouping of records which preserves an original shape of the historical data and preserves main characteristics of the historical data.

25. The system of claim 20, wherein the method further comprises:
weighting at least one of the at least one generated multiple machine learning models.

26. The system of claim 20, wherein the method further comprises:
determining a prediction interval; and
determining the range of values for the at least one project attribute of the at least one new project in accordance with the determined prediction interval.

27. The system of claim 20, wherein an allocation of resources for the at least one project is based on the range of values determined for the at least one project attribute of the at least one new project.
